(19) United States
(12) Patent Application Publication
(10) Pub. No.: US 2025/0123616 A1
(43) Pub. Date: Apr. 17, 2025

(54) METHOD FOR PROVIDING OPERATING DATA OF A TRANSPORT SYSTEM IN A MACHINE LINE

(71) Applicant: Krones AG, Neutraubling (DE)

(72) Inventors: Johannes STRAUSS, Wolfsegg (DE); Jonas BIELMEIER, Regensburg (DE); Christian MEYKNECHT, Burglengenfeld (DE)

(21) Appl. No.: 18/910,866

(22) Filed: Oct. 9, 2024

(30) Foreign Application Priority Data
Oct. 13, 2023 (DE) 10 2023 128 054.6

(51) Int. Cl. G05B 19/418

(52) U.S. Cl. CPC G05B 19/4189; G05B 2219/31232; G05B 2219/31376

(57) ABSTRACT

A method for providing operating data of a transport system in a machine line, e.g. for filling and packaging foods and/or beverages. The machine line includes a multiple machines and at least one transport system. A material flow of the machine line includes the transport system and at least one of the machines. The transport system includes one or more devices. The method starts with creation of one or more functional modules. Each of the functional modules fulfills a specific standardized function within the machine line. Each of the functional modules functionally represents one or more of the devices along a material flow within the machine line. For each of the functional modules, a standardized PLC interface is provided for outputting standardized information as operating data of the functional module. The operating data include a status, an operating parameter, or an error message of the functional module.

### CROSS REFERENCE TO RELATED APPLICATION

The present application claims priority to German Patent Application No. 10 2023 128 054.6 filed on Oct. 13, 2023. The entire contents of the above-listed application are hereby incorporated by reference for all purposes.

### TECHNICAL FIELD

The disclosure relates to a method for providing operating data of a transport system in a machine line, as well as a machine line with a transport system, in particular a machine line for filling and packaging food and/or beverages.

### BACKGROUND

Today's filling and packaging plants in the beverage and liquid food industry are highly optimized and process up to 120,000 units per hour. A typical filling and packaging plant includes a variety of different machines and modules that are connected to each other via conveyor belts. The units such as bottles, cans, pallets, containers, or the like are transported from one machine to the next and pass through the individual machines of the line in a predetermined order.

### SUMMARY

The failure of a single machine in such a machine line represents a disruption that spreads along the flow of material and forces other machines to stop. In order to maintain performance at a high level, a continuous analysis process must take place to identify and consistently correct weak points within the line.

It is therefore important to identify as quickly as possible, in the event of a failure of several machines, the machine or intermediate regions between two adjacent machines in the line that is responsible for the stoppage of the line or part of the line. Until now, this task was mainly accomplished through expertise, with an expert of the complex machine line examining the plant based upon experience to identify the fault. However, this manual approach is mostly based upon experience and is usually time-consuming.

Filling lines consist of machines (filler, labeler, cleaning machine, pasteurizer, packer, loader, etc.) as well as a network of conveyors and “smaller” devices connected thereto such as dating systems, carton sealers, empty container storage, etc. The network of conveyors and the smaller devices is hereafter referred to as the “transport system.”

While the above-mentioned machines themselves usually have a special data interface via which error messages and status reports can be issued, transport system data are not (1st case) or only highly aggregated, based upon switch-on groups (2nd case), made available for higher-level IT systems.

In the 1st case (no connection to transport system data), there is no transparency (historical/live) about the status of the transport system. An analysis of the filling plant is therefore limited to machine data, and “blind spots” arise.

In the 2nd case (connection of aggregated transport system data), there are disadvantages in order picking due to a compromise between generic PLC implementation (little effort in order picking, increasing effort due to lack of transparency in analysis on BDE system), or customized system-dependent, individual PLC implementation (high effort at PLC level, resource and scaling problems due to necessary expert knowledge, no comparability of plants due to individuality, slightly reduced effort in analysis due to improved transparency).

From the switch-on groups as they currently exist, it is not clear which functions this switch-on group fulfills. This varies depending upon the line layout and/or for each individual customer.

A data interface in existing systems is based upon switch-on group status. In principle, there are also message texts that can provide an indication of which function of the switch-on group is faulty, but a switch-on group can display only one active fault at a time. This makes it very difficult to summarize a status on a switch-on group and create transparency about the status.

Transport system data (such as statuses, error messages, diverter positions) are essential for assessing production interruptions, evaluating line key figures, and for potential analyses to increase overall plant effectiveness.

There is therefore a need for improved machine lines and improved methods for providing operating states of a transport system in a machine line.

This object is achieved according to the disclosure by a method and a machine line as disclosed herein.

One embodiment of the disclosure relates to a method for providing operating data of a transport system in a machine line, in particular in a machine line for filling and packaging foods and/or beverages. The machine line includes a plurality of machines and at least one transport system. At least one material flow of the machine line includes the transport system and at least one of the machines. The transport system includes one or more devices. The method starts with the creation of one or more functional modules. Each of the one or more functional modules fulfills a specific standardized function within the machine line. Each of the one or more functional modules functionally represents one or more of the devices along a material flow within the machine line. Thereafter, for each of the one or more functional modules, a standardized programmable logic controller (PLC) interface is provided for outputting standardized information as the operating data of the functional module. The operating data include a status, an operating parameter, or an error message of the functional module.

One embodiment of the disclosure relates to a machine line in which the above method is implemented.

### BRIEF DESCRIPTION OF THE FIGURES

Exemplary aspects of the disclosure are shown in the drawings. In the figures:

FIG. 1: is an exemplary section of a filling plant;

FIG. 2: is an exemplary section of a filling plant as known in line management systems from the prior art;

FIG. 3: is an exemplary section of a filling plant according to embodiments of the disclosure in line management systems;

FIG. 4: is an exemplary plant configuration for PET containers and adhesive containers;

FIG. 5: is an exemplary plant configuration for PET containers and shrink packers;

FIG. 6: is an exemplary plant configuration for cans or glass bottles; and

FIG. 7: is an exemplary plant configuration for cans.

### DETAILED DESCRIPTION

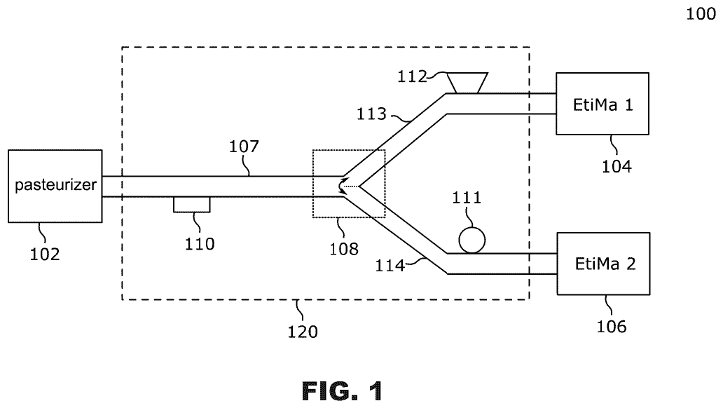

FIG. 1 shows an exemplary section of a filling plant (machine line) 100 as it usually occurs. Three machines are shown in FIG. 1. The three machines are a pasteurizer 102, a labeling machine (EtiMa) 104, and a second EtiMa 106. The machines 102, 104, and 106 themselves are typically equipped with sensors and data interfaces so that they can be regularly controlled by the user and can communicate their operating status.

The machines 102, 104, and 106 are connected to each other via a transport system which includes the conveyors 107, 113, 114 and the diverter 108. The transport system is therefore composed of a network of conveyors 107, 113, 114, a diverter 108, and other smaller devices which are shown as examples in FIG. 1 as elements 110, 111, and 112.

Examples of such devices 110, 111, 112 can be a dating system, a carton sealer, an empty container storage device, or similar devices. However, these are only examples, and in particular, the devices can be any of the following devices: devices that process packages/packaging components (in particular dating, sealing, wrapping, and/or drying) and/or devices that inspect packages/packaging components (in particular weighing and/or optically inspecting) and/or devices that control the material flow of packages/packaging components (in particular transporting, merging, ejecting, diverting, buffering, supplying, and/or dispensing).

Characteristic of these devices 110, 111, 112 and also the diverter 108 is that they generally have no connection to transport system data, or only a connection to aggregated transport system data. For example, these elements and possibly also the conveyors are combined to form a switch-on group 120, so that this switch-on group 120 can output only one overall state.

A switch-on group usually includes a large number of individual modules that would otherwise have to be switched on or off individually. Therefore, they are grouped into switch-on groups which are all switched on together. However, these switch-on groups include larger regions that can also combine different product flow routes in one switch-on group. Therefore, the currently existing switch-on groups are only of very limited use for attaining high-resolution error propagation.

An aim of the disclosure is the provision, acquisition, analysis, and control of operating data of transport systems in beverage filling plants. This is achieved according to embodiments of the disclosure described herein by means of so-called functional modules.

The overall task of the transport system differs individually for each line, product, and customer. The individual overall task can be fulfilled by several standardized functions. The building blocks of which a transport system can consist according to embodiments can be encapsulated in functions in order to offer individual status messages and also control interfaces for specifically these function blocks or functional modules.

Functions according to embodiments can, for example, be: “transporting,” “dating,” “dividing container flow,” “redirecting container flow,” “merging container flow,” “storing empty pallets,” “drying containers,” “closing boxes,” “inspecting containers,” etc. The particular overall task of the transport system is therefore made up of several standardizable functional modules which can also occur several times in the overall system. These functional modules, each of which fulfills a function/task, can be encapsulated in the PLC (automation).

This can be done as follows, according to some embodiments.

First, a PLC (programmable logic controller) can provide a standardized interface for each of these modules. This enables the provision of relevant information about the function and interface to control functional modules, as described later. The interface shall be able to control a functional module and retrieve operating states therefrom.

According to embodiments, an operating data acquisition system can record this standardized, relevant information and output it for further use/evaluation. The analysis of line functions, calculation of transport system key figures and reports, visualization of the system, etc., can use this standardized information.

As already described, a line management system can use the interface of the functional modules to control them (e.g., to influence the product flow through the line or to change settings for a printer, etc.).

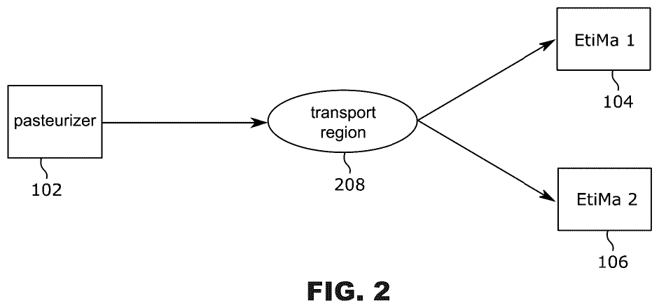

When creating the functional groups, the material flow through the machine line must be taken into account. This is shown in particular in the example from FIG. 1, which is further developed in FIG. 2 and beyond.

FIG. 2 shows a representation of the machine line section as it is visualized in the prior art—for example, in a line management system. It is only shown that the machines 102, 104, and 106 are connected to each other via a transport section 208. However, it is not clear which elements are located behind the transport section 208, and, in the event of a fault in the transport section 208, it also cannot be shown where in the transport section-which can consist of several branches—the error occurred, since a production plant consists of machines that are connected to one another via transport systems similar to a transport network with branches, junctions, dynamic branches during the production process, etc.

In order to be able to better resolve this transport section 208 in FIG. 2, according to embodiments of the disclosure, when cutting (i.e., creating) the functional modules, these are created in such a way that it is clear what the product flow is. In order to visualize the material flow and the operating status at all times, no functional modules may be cut in an overlap across multiple routes.

If a diverter is contained in the transport system, and the production flow for a certain sub-production process goes in a first direction, and the switch-on group were to include elements of the first (e.g., left) and the second (e.g., right) transport system, then one would not know which route exactly is affected by a disruption.

Therefore, in embodiments of the disclosure, the functional modules are cut so that they include a fixed part of a route with unchangeable material flow. The diverter can, for example, be described/used/created/typed as its own standardized function—i.e., as its own functional module.

If the diverter itself then has a fault, the diverter can include, as a standardized function, information that can be output via the PLC interface, such as: “Current flow controlled to the left/right.” Although there are many different configurations of diverters that physically function differently, each diverter can still output this standardized message via the PLC interface.

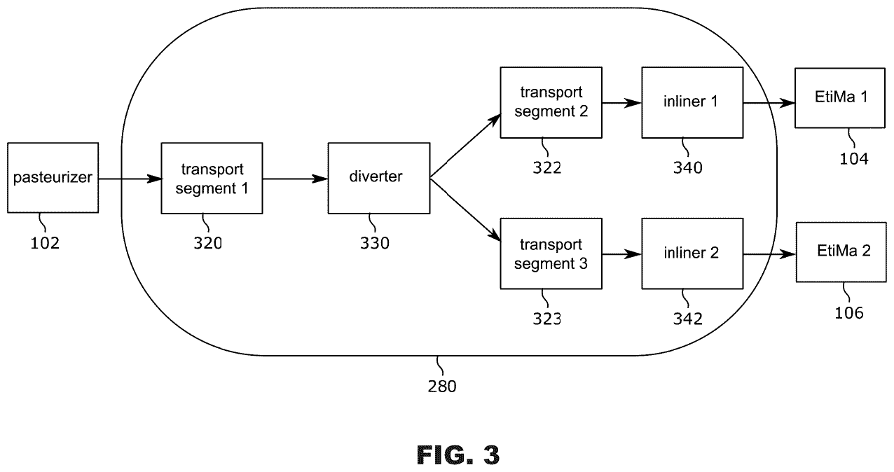

As shown in FIG. 3, a higher resolution of the transport section can thereby be achieved by connecting the functional modules to each other—similar to a map—and it is therefore possible to display the status of each functional module and therefore the material flow on an overview at any time.

From this linking of functional groups which are connected to each other via particular PLC interfaces, a possible error propagation can be detected. Using the information from the functional modules, a system can estimate at which point certain disturbances can have what effects, such as production interruptions, jamming, lack of transported material, etc.

The example in FIG. 3 shows how the transport system 208 from FIG. 2 can be further broken down by means of functional modules. The transport system 208 includes the functional modules of the transport segment 320, 322, 323, the diverter 330, and the inline 340 and 343. These functional modules from FIG. 3 can each be a single machine or a combination of several machines that are functionally combined into a functional module.

The operating data of a functional module can be output to the PLC interface by a signal from a device in the functional module, or by a signal from one or more sensors in the functional module.

According to embodiments of the disclosure, a method is provided for providing operating data of a transport system in a machine line, in particular in a machine line for filling and packaging food and/or beverages. As mentioned, the machine line includes a variety of machines and at least one transport system. At least one material flow of the machine line includes the transport system and at least one of the machines. The transport system includes one or more devices.

The method starts with the creation of one or more functional modules. Each of the one or more functional modules fulfills a specific standardized function within the machine line. Each of the one or more functional modules functionally represents one or more of the devices along a material flow within the machine line.

Thereafter, for each of the one or more functional modules, a standardized programmable logic controller (PLC) interface is provided for outputting standardized information as the operating data of the functional module. The operating data include a status, an operating parameter, or an error message of the functional module.

By means of the PLC interface, the standardized information of the one or more functional modules can be output and/or recorded.

With the functional modules, as described here in embodiments, and the standardized control interface of the transport system for filling lines, greater transparency across complex lines results. The so-called digital twin of the machine line is improved and includes a higher systematic resolution. The high level of transparency across complex lines prepares the way for numerous future digitization products.

Further advantages of the disclosure described herein are greater flexibility for optional, use-case-related aggregation by providing granular information at the OT level, and low picking-dependent effort in transport system planning through layout-independent standardization. Layout-independent standardization using functional modules creates data quality and comparability, whereby little expert knowledge is required for picking.

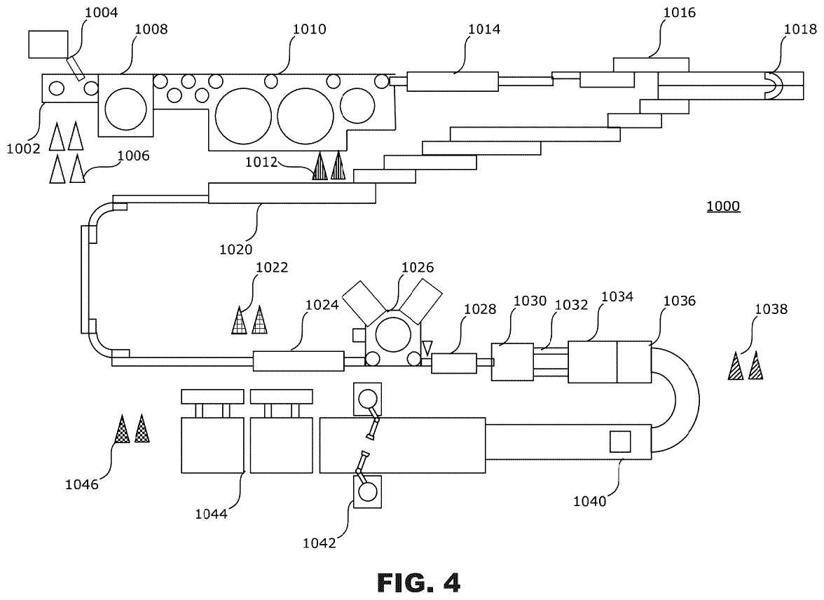

In the following FIGS. 4 to 7, various exemplary plant configurations for different bottle filling plants are described in which the disclosure or at least parts and aspects of the disclosure can be implemented. The description of FIGS. 4 to 7 is intended only to provide a general overview of machines for which state data can be collected, on the basis of which the LLM can process user requests.

FIG. 4 shows an exemplary plant configuration 1000 for PET bottles or PET containers and adhesive containers. As can be seen in FIG. 4, the plant configuration 1000 includes the most varied modules, which form a line at the end of which the ready-filled PET containers are dispensed in the form of a bundle on pallets. Some of the modules and machines can be optional, and the disclosure is not limited to the exact shape and arrangement of the plant configurations.

The plant configuration 1000 includes a furnace 1002 for preforms, a preform sorting system with a feeding machine 1004, and a blow-molding machine 1008. Modules 1002, 1004, and 1008 form in general a stretch blow-molding machine in which PET containers are manufactured and formed from a raw material. The produced PET containers are forwarded to a filler 1010 in which the bottles are filled. The filler can optionally include a rinser. Various particles such as dust, cardboard, or remains of wooden pallets can collect in the preforms during storage or transport. These can be removed with the rinser. At the end of the filler, a closer can be arranged, by means of which the PET containers are closed after filling.

Optionally, the plant configuration 1000 can, after the filler 1010, include a rotating apparatus, which is used for hot filling of the PET containers. The filled PET containers are guided to a separator 1020 and further to a drying apparatus 1024 in which the PET containers are dried via one or more conveyor belts 1016, which can also include a buffer 1018 for intermediate loading of filled containers.

After drying, the PET containers are conveyed to a labeling machine 1026. The labeling machine 1026 can be configured for various labeling techniques such as labeling using hot glue, cold glue, self-adhesive labels, or sleeves. After printing or labeling the PET containers, the PET containers are passed through a second drying apparatus 1028, a line distributor 1030, conveyor belts 1032, adhesive container production 1034, and a curing section to a handle applicator. In adhesive packaging production 1034, the PET containers are grouped together in certain group sizes and packaged into a pack such as a “six-pack.” In the handle applicator, a carrying handle is attached to the pack, which allows the pack to be carried comfortably. The finished packs are then accordingly arranged by a robot 1042 for layer production and packed on pallets by a palletizer 1044.

In the plant configuration 1000, so-called format trolleys or format racks can be arranged on various modules and machines in order to provide quickly changeable format sets for short changeover times and automatic tool exchange. Examples of format trolleys are the format trolley 1006 for the blow-molding machine 1008, the format trolley 1012 for the filler 1010, the format trolley 1022 for the labeling machine 1026, the format trolley 1038 for the adhesive packaging production 1034, and the format trolley 1046 for the palletizer 1044.

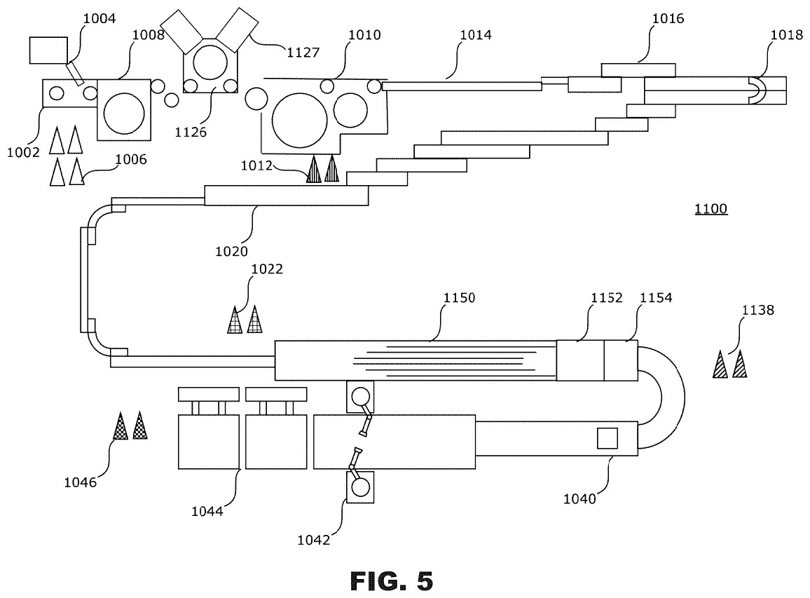

FIG. 5 shows another exemplary plant configuration 1100 for PET containers and shrink packers. The plant 1100 in FIG. 5 includes many of the modules and machines from the plant configuration 1000 in FIG. 4, but there are some differences. The description of the modules that are already described in connection with FIG. 4 is therefore omitted for FIG. 5.

A key difference between the two exemplary plant configurations 1000 and 1100 is that the labeling machine 1126 with the labeling modules 1127 can already be installed after the blow-molding machine 1008 and before the filler 1008. For this purpose, the plant configuration 1100 can include six transport lanes 1150 into which the PET containers can be pushed. After the PET containers have been correspondingly pushed into one of the six lanes 1150, they are conveyed into the film wrapping module 1152 and then into the shrink tunnel 1154.

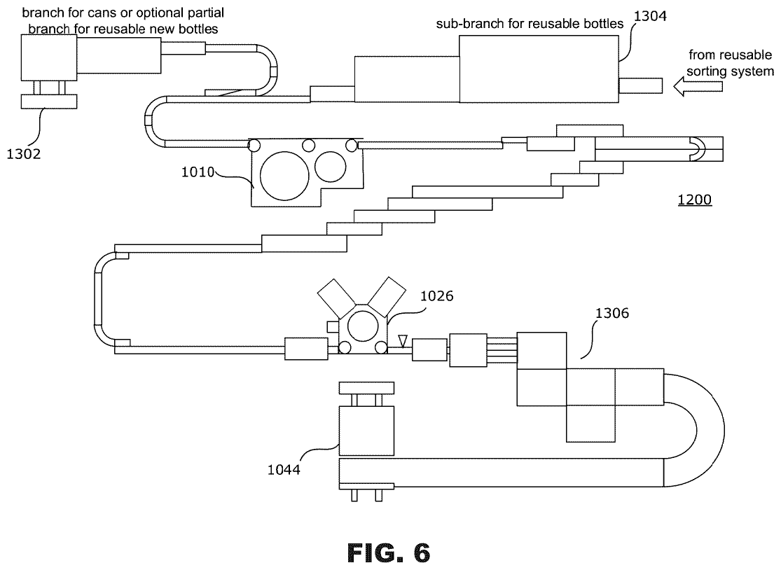

FIG. 6 shows an exemplary plant configuration 1200 for cans or glass bottles. The exemplary plant configuration 1200 from FIG. 6 again has some similarities to the plant configurations 1000 and 1100 from FIGS. 4 and 5, and the description of the plant configuration is therefore limited to the differences between the plant configurations.

As shown in FIG. 6, the exemplary plant configuration can include two separate feeds. A first feed, on the left in FIG. 6, shows a branch for cans or, optionally, a partial branch for reusable new bottles. The containers, i.e., cans or new bottles, are fed from a depalletizer 1302 into the machine, where they are guided via conveyor belts to the filler 1010. A second feed, on the right in FIG. 6, shows a partial branch for reusable bottles, which are introduced into the plant from a reusable sorting system (not shown).

In the case where the reusable bottles that have already been used are introduced into the system 1200 via the sub-branch for reusable bottles, the reusable bottles first pass through the cleaning machine or washing machine 1304. Another possible difference of the exemplary plant configuration 1200 is the transfer packer 1306 after the labeling machine 1026. The transfer packer can sort the bottles or cans into a carton clip application or into boxes, or both.

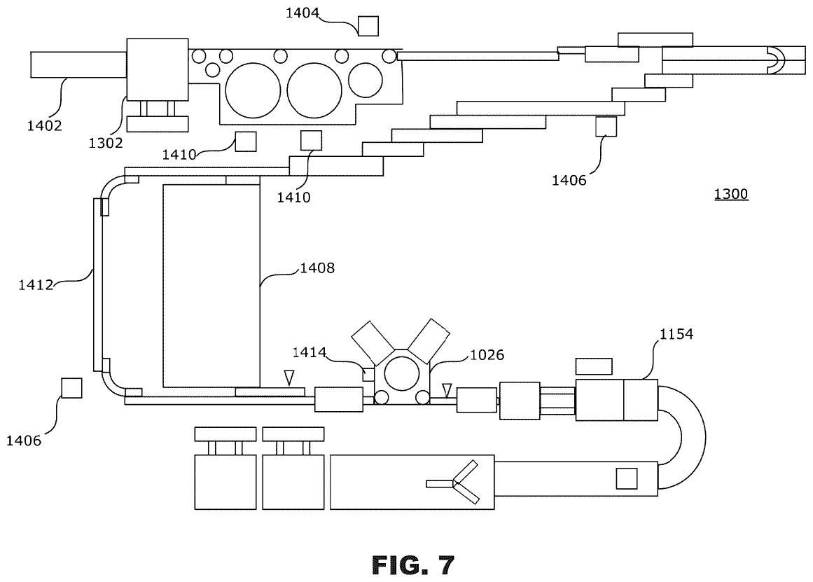

FIG. 7 shows an exemplary plant configuration 1300 for cans, in which the elements already described in the other plant configurations are not described. The cans in the plant configuration 1300 are introduced from a magazine 1402 with cans into the depalletizer 1302. The cans, after they have passed through the filler and are filled, are closed by means of a closure magazine 1404 and are then transported further along the plant 1400 via the conveyor belts as described above.

The optional pasteurizer 1408 can be circumvented via the bypass 1412 if it is not required. In the pasteurizer 1408, the freshly filled products can be pasteurized for preservation.

In contrast to the plant configurations 1000, 1100, and 1200, the exemplary plant configuration 1300 shows various tanks for corresponding consumables, such as the tanks 1410 with rinsing liquid and/or the filling product, and the tanks 1406 with belt lubricant. These tanks can also be contained in the above-described exemplary plant configurations. For example, the chemical products 106 that are fed from the mixer 110 to the machines can be stored in the tanks 1406 and 1410.

The invention claimed is:

1. A method for providing operating data of a transport system in a machine line wherein the machine line includes a plurality of machines and at least one transport system, wherein:
at least one material flow of the machine line includes the transport system and at least one of the machines, and
the transport system includes one or more devices,
wherein the method includes:
creating one or more functional modules, wherein each of the one or more functional modules fulfills a specific standardized function within the machine line, and wherein each of the one or more functional modules functionally represents one or more of the devices along a material flow within the machine line;
providing, for each of the one or more functional modules, a standardized programmable logic controller (PLC) interface for outputting standardized information as the operating data of the functional module, wherein the operating data include a status, an operating parameter, or an error message of the functional module; and
recording or outputting, via the PLC interface, the standardized information of the one or more functional modules.

2. The method according to claim 1, wherein the one or more functional modules are further adapted to be controlled via the PLC interface.

3. The method according to claim 1, wherein the one or more devices include:
devices that process packages/packaging components; and/or
devices that inspect packages/packaging components; and/or
devices that control the material flow of packages/packaging components.

4. The method according to claim 1, wherein a functional module includes a fixed part of a route within the machine line with unchangeable material flow.

5. The method according to claim 1, wherein the standardized information of the one or more functional modules is used to analyze a line function, to calculate transport system key figures and reports, and/or to visualize the machine line.

6. The method according to claim 1, wherein the operating data of a functional module are output to the PLC interface by a signal from a device in the functional module or by a signal from one or more sensors in the functional module.

7. The method according to claim 1, wherein two or more functional modules are connected to one another and describe the material flow at any time via the particular PLC interface.

8. A machine line that is configured to provide operating data of a transport system in the machine line, wherein the machine line includes a variety of machines, at least one transport system, one or more functional modules, and a standardized programmable logic controller (PLC) interface for each of the one or more functional modules;
wherein:
at least one material flow of the machine line includes the transport system and at least one of the machines, and
the transport system includes one or more devices;
wherein each of the one or more functional modules fulfills a specific standardized function within the machine line, and wherein each of the one or more functional modules functionally represents one or more of the devices along a material flow within the machine line;
wherein the standardized PLC interface is for outputting standardized information as the operating data of the functional module, wherein the operating data include a status, an operating parameter, or an error message of the functional module; and
wherein the PLC interface is configured to record or output the standardized information of the one or more functional modules.

9. The machine line according to claim 8, wherein the one or more functional modules are controlled by a line management system via the particular PLC interfaces.

10. The machine line according to claim 9, further comprising:
at least one sensor in a functional module, wherein the operating data of the functional module are output to the PLC interface by a signal from the at least one sensor.

11. The method according to claim 1 wherein the machine line is for filling and packaging food and/or beverages.

12. The method according to claim 1, wherein the one or more devices include:
devices that process packages/packaging components including dating, sealing, wrapping, and/or drying; and/or
devices that inspect packages/packaging components including weighing and/or optically inspecting; and/or
devices that control the material flow of packages/packaging components, including transporting, merging, ejecting, diverting, buffering, supplying, and/or dispensing.
